(19) United States
(12) Patent Application Publication
(10) Pub. No.: US 2026/0278131 A1
(43) Pub. Date: Sep. 17, 2026

(54) SYSTEMS AND METHODS FOR ESTABLISHING A TEST ENVIRONMENT THAT IS CROSS-COMPATIBLE WITH A PLURALITY OF CLIENT DEVICES TO SECURELY COMMUNICATE DATA

(71) Applicant: Capital One Services, LLC, McLean, VA (US)

(72) Inventors: Austin LAU, Plano, TX (US); Daniel KRUEGER, Irving, TX (US); Kuldeep Kashinath MARGANACHE, Frisco, TX (US)

(73) Assignee: Capital One Services, LLC, McLean, VA (US)

(21) Appl. No.: 19/080,701

(22) Filed: Mar. 14, 2025

(51) Int. Cl. G06F 21/62; G06F 16/23; G06F 16/248

(52) U.S. Cl. CPC G06F 21/6218; G06F 16/23; G06F 16/248

(57) ABSTRACT

Systems and methods for establishing a secure storage environment to reduce data interception during cyberattacks targeting unsecured environments are disclosed. For example, a system can be configured to obtain, in accordance with a browsing context, user input indicating a request to display a user interface for a webpage hosted by a first data source that is unsecured. The system can obtain webpage data from the first data source and determine a unique identifier for a secured web element that identifies a second data source different from the first data source. In response to determining the unique identifier for the secured web element, the system can execute operations to establish a secured storage environment that is segmented from one or more other storage environments maintained by the webpage and provide at least a portion of the data in the secured storage environment to the second data source.

### BACKGROUND

Establishing a development environment for executing functional tests involves developers configuring frameworks to establish a computing environment where software can be tested. Typically, this process includes installing an integrated development environment (IDE), which provides a platform for writing, debugging, and managing code. Version control systems can also be configured to track changes and maintain software integrity as the underlying code is evaluated and revised in response to test performance. Once these components of the development environment are established, testing frameworks can be configured and used to execute test cases that validate the functionality of the software.

However, there are several technical pitfalls associated with this process. One common issue is the potential for misconfiguration of the testing environment, which can lead to inaccurate test results along with the wasting of computing resources executing functional tests that had little to no chance of being successfully executed. For example, incorrect setup of the IDE or version control system can result in code conflicts and integration issues, consuming excessive processor and memory resources when executing functional tests as they fail due to configuration errors. If the development environment is not optimized, software that is reconfigured after iterative adjustments may experience slower build times due to increased resource demands for recompilation and execution. And network communication can also be impacted if the testing environment relies heavily on remote servers or cloud-based services, resulting in increased latency as additional communications may be involved in the reconfiguring and re-execution of the functional tests or the testing environment itself. These issues can hinder the development process, increase the amount of time involved in testing and iteratively adjusting software, and affect the overall quality of the software.

### SUMMARY

In view of these challenges, systems and methods are described herein relating to novel uses and/or improvements when establishing a test environment that is cross-compatible with a plurality of client devices and providing access to test data stored in the test environment during execution of functional tests by the plurality of client devices. By configuring a test environment as described herein to execute functional tests against scenarios maintained in a content distribution system, significant technical advantages are realized that result in reduced computing resource consumption, including reduced network communication. First, by determining whether data for an appropriate scenario is available before generating queries, the system can minimize unnecessary processing both at the device (e.g., a network component such as a server) and at the content distribution system (e.g., a database maintained by the network component or independently by a separate server). In this approach, the testing environment avoids executing redundant or irrelevant queries, thereby reducing processor usage and memory consumption. Second, by only retrieving relevant data from the content distribution system, network communications are optimized, as the volume of transmitted data is minimized. This streamlined process not only enhances overall efficiency but also ensures that resources are allocated effectively, reducing the likelihood of bottlenecks and improving system performance during testing. And third, this testing environment can also facilitate cross-compatibility between devices that typically operate with different programming languages or platforms by utilizing frameworks that support multiple languages. For instance, certain services can allow test scripts to be written in languages such as Java, Python, or C #, enabling the same test logic to be applied across different devices with different deployment environments. Establishing a framework that allows for cross-platform compatibility can help bridge the gap between devices running different operating systems or languages, ensuring that applications behave consistently across various platforms without the need for configuring scenario datasets for each of these otherwise incompatible platforms. This simplifies the testing process by allowing developers to write functional tests once and execute them on multiple devices, thereby reducing the complexity and effort required for cross-device testing.

In some aspects, systems and methods for executing functional tests involve developers configuring frameworks to establish a computing environment where software can be tested are described. For example, a system can establish a communication connection between a client device and a server in accordance with an application programming interface (API). The system can then receive a first query from the client device, the first query requesting data stored across one or more tables of a database accessible by the server. The results of the first query can be used to perform one or more functional tests at the client device. The system can then determine that the first query satisfies a first scenario from among a plurality of scenarios, the first scenario representing a set of relationships between the one or more tables of the database. In response to determining that the first query satisfies the first scenario, the server can generate a second query based on a mapping associated with the API. This mapping can specify one or more operations involved in converting the first query into the second query (e.g., represented in accordance with a second format). The system can provide the second query to the server in accordance with the API to cause the server to return a first query result represented in accordance with the second format. A second query result can be generated based on the first query result and the mapping of the first format to the second format. And the server can then provide the second query result to the client device to allow the client device to perform the one or more functional tests using the second query result.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows a diagram of an environment for establishing a test environment that is cross-compatible with a plurality of client devices, in accordance with one or more embodiments.

FIG. 2 shows a diagram of a process for establishing a test environment that is cross-compatible with a plurality of client devices, in accordance with one or more embodiments.

FIG. 3 shows a diagram of an example implementation of string matching, in accordance with one or more embodiments.

FIG. 4 shows a diagram of an example implementation of obtaining test data in response to execution of one or more queries, in accordance with one or more embodiments.

FIG. 5 shows components for a system used for establishing a test environment that is cross-compatible with a plurality of client devices, in accordance with one or more embodiments.

FIG. 6 shows a flowchart of the steps involved in a process for establishing a test environment that is cross-compatible with a plurality of client devices, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention can be practiced without these specific details or with an equivalent arrangement. In other cases, well-known structures and devices are shown in block diagram form in order to avoid unnecessarily obscuring the embodiments of the invention.

Some of the systems and methods described herein can be configured to establish a test environment in which a client device and a server can communicate when analyzing and processing queries requesting data from one or more tables in a database that can be used to perform functional tests on the client device. These systems can determine if the first query matches a predefined scenario, which represents relationships according to which the data is stored in the database. If the first query matches the predefined scenario, the system can generate a second query based on a mapping, converting the first query into a second format. This second query can then be sent to a system such as a content distribution system (described herein), which can process and return a result in the second format. This result can then be provided to the client device, allowing the client device to perform the functional tests described.

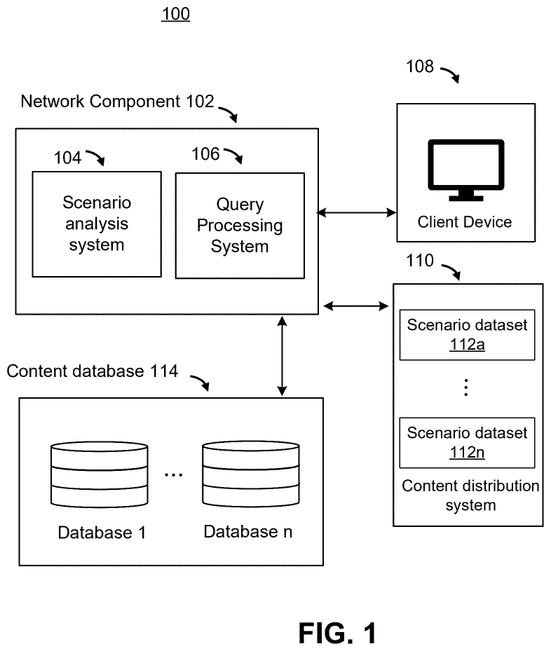

FIG. 1 shows a diagram of a testing environment (referred to as environment 100) that can be configured to, among other things, establish a test environment that is cross-compatible with a plurality of client devices, in accordance with one or more embodiments. For example, the environment 100 can include a network component 102 having one or more components as described herein, a client device 108, a content distribution system 110, and a content database 114. The network component 102 (e.g., one or more components of the network component 102), the client device 108, the content distribution system 110, and/or the content database 114 can be configured to interconnect using one or more wired and/or wireless connections. As will be understood, the environment 100 includes a network component 102, the client device 108, the content distribution system 110, and/or the content database 114, but similar environments can include more devices that are the same as, or similar to, those described.

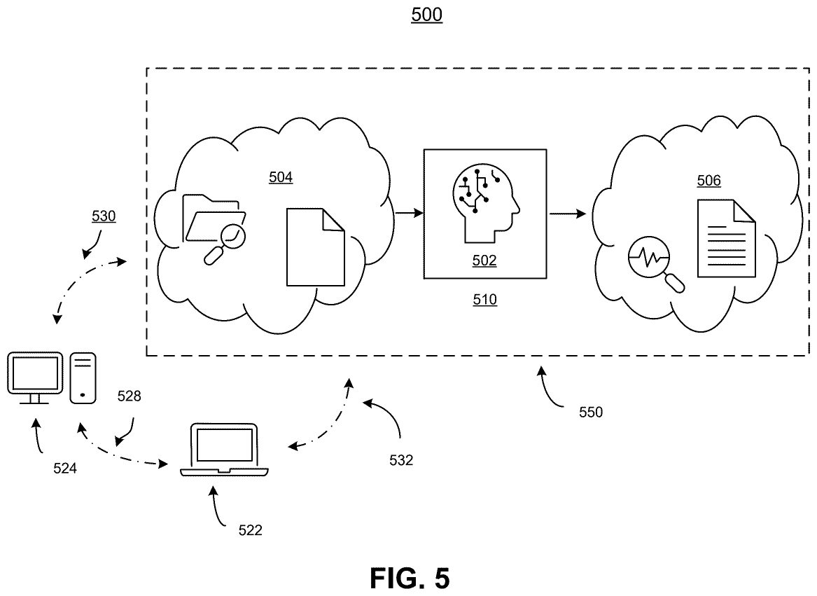

In some embodiments, the network component 102 can include a computing device that is configured to be in communication with the client device 108, the content distribution system 110, and/or the content database 114 using one or more communication paths (also referred to as communication connections) as described herein. For example, the network component 102 can include a desktop computer, a laptop computer, a smartphone, a tablet, and/or the like. In some embodiments, the network component 102 can include (e.g., implement) a scenario analysis system 104 and/or a query processing system 106. While certain components are illustrated by FIG. 1, the network component 102 can include and/or exclude one or more of the illustrated components. The network component 102 can also include one or more components that are the same as, or similar to, the user terminal 524 of FIG. 5. As described herein, the network component 102 (e.g., one or more components of the network component 102) can establish one or more secured or unsecured communication connections with the client device 108, the content distribution system 110, and/or the content database 114.

In some embodiments, the client device 108 can include a computing device that is configured to be in communication with the network component 102 using one or more communication connections as described herein. For example, the client device 108 can include a desktop computer, a laptop computer, a smartphone, a tablet, and/or the like. In some embodiments, the client device 108 can include (e.g., implement) at least a portion of a testing environment within which software that is being developed can be tested using one or more functional tests. As described herein, the client device 108 (e.g., one or more components of the network component 102) can establish one or more secured or unsecured communication connections with the network component 102.

In some embodiments, the content distribution system 110 can include a computing device that is configured to be in communication with the network component 102 using one or more communication connections as described herein. For example, the content distribution system 110 can include a desktop computer, a laptop computer, a smartphone, a tablet, and/or the like. In some embodiments, the content distribution system 110 can include (e.g., implement) a database that maintains one or more scenario datasets, including, for example, scenario dataset 112a-112n (referred to individually as a scenario dataset 112 or collectively as scenario datasets 112 where contextually appropriate). In some examples, a scenario dataset 112 can include data that matches a particular schema or a set of databases with data that match particular schemas and point to one another in a specific manner by defining the relationships and interactions between the tables within the database(s). In this example, a scenario can capture the structure and organization of the data, including how tables are linked through foreign keys, indexes, and other relational constructs. For instance, a scenario might describe a customer database where the customer table is linked to an orders table, which in turn is linked to a products table. This scenario would outline how queries can traverse these relationships to retrieve relevant data. In some examples, scenarios can represent more complex setups involving multiple databases with interconnected schemas, ensuring that data retrieval operations consider the intricate web of relationships across different databases.

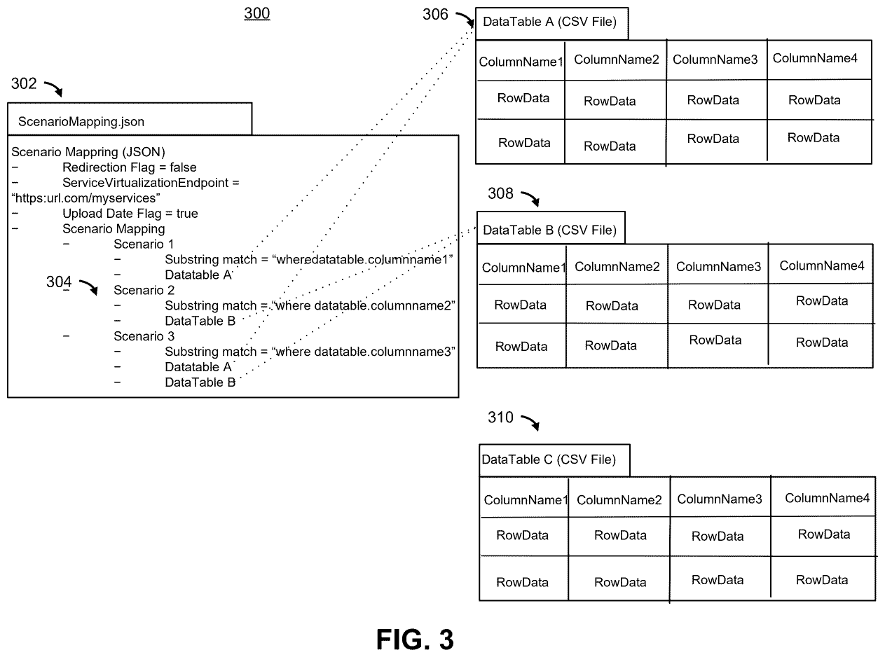

While certain components are illustrated by FIG. 1, the environment 100, or the various devices thereof, can include and/or exclude one or more of the illustrated components. The environment 100 can also include one or more components that are the same as, or similar to, the devices of FIG. 3. In some embodiments, the devices of the environment 100 can be configured to establish direct or indirect communication connections between one another. For example, one or more networks can establish communication paths between one or more of the devices of the environment 100 to allow for the communication of messages (e.g., network packets, etc.) therebetween. In this example, the communication paths can be the same as, or similar to, the communication paths 528, 530, and 532 of FIG. 5. The network(s) can include mobile phone networks, mobile voice or data networks, cable networks, public switched telephone networks, the Internet, or other types of communications networks or combinations of communications networks as described herein.

It will be understood that the number and arrangement of devices in the environment 100 are provided as an example and that there can be differently arranged environments than those shown in FIG. 1. In some embodiments, at least some of the device(s) and/or system(s) of FIG. 1 can be implemented by a single device or multiple devices within a distributed system. For example, the network component 102 can be implemented by a single device or as multiple devices that, either alone or in coordination, perform one or more of the operations as described herein.

With continued reference to FIG. 1, one or more of the components of the environment 100 can be configured to execute operations as described herein to establish a test environment and provide access to test data stored in the test environment during execution of functional tests by a plurality of client devices.

In some embodiments, the network component 102 can be configured to establish a communication connection with one or more client devices 108. For example, the network component 102 can include a server that is configured to establish one or more communication connections with one or more client devices 108 of the environment 100. The communication connections can be established in accordance with an application programming interface (API). For example, the client device 108 can receive input (e.g., from one or more developers when developing software as described herein) that causes the client device to implement a test environment and execute one or more functional tests to test the software within that environment. In this example, the client device 108 can then establish a communication connection with the network component 102 in order to obtain data involved in the execution of the functional tests within the test environment.

In some embodiments, the network component 102 can receive a first query from the client device 108. For example, the network component 102 can receive a first query from the client device 108 that requests data that is stored in a database accessible by the network component 102. In this example, the first query can be configured to cause the network component 102 to obtain data stored in either the content distribution system 110 or the content database 114. For example, the first query can be configured to cause the network component 102 to initially attempt to obtain the data stored in the content distribution system 110. However, if the data stored in the content distribution system 110 is not matched with the first query, the first query can also be configured to cause the network component 102 to attempt to obtain the data stored in the content database 114 that matches the first query. The first query can be represented in accordance with a first format.

In some embodiments, the first query can be represented using a first programming language. For example, the first query can be represented as a structured query language (SQL) query, an unstructured data query, etc. In some examples, the first query can be used by the network component 102 to obtain data that is maintained across multiple tables using foreign keys, which represent specific relationships between the subcomponents of the query. For example, in a relational database, a table can be linked through foreign keys, which include columns that establish a relationship between data in different tables. In some embodiments, the first query can be matched with (e.g., compatible with) one or more scenario datasets 112 within the content distribution system 110. As a result, the first query can be matched with one or more scenario datasets 112 that, when queried, return data that can be used to execute functional tests.

In some embodiments, the first query can be configured to cause the network component 102 to process the first query and determine whether one or more scenario datasets 112 within the content distribution system 110 match the scenario associated with that query. To determine whether one or more scenario datasets 112 within the content distribution system 110 satisfy the first scenario, the network component 102 can execute a scenario analysis system 104. For example, the first query can be configured to cause the scenario analysis system 104 to determine whether one or more scenario datasets 112 within the content distribution system 110 are associated with data that satisfies the first scenario. In examples described, each scenario can represent a set of relationships between one or more tables of a database (or one or more components of each table) maintained in accordance with a scenario dataset 112 according to which data is accessible. To determine whether one or more scenario datasets 112 satisfy the first scenario, the scenario analysis system 104 can compare one or more aspects of the first query to the set of relationships established by the tables used to maintain the data in each of the scenario datasets 112 stored in the content distribution system 110. This comparison can involve determining a comparison result indicating whether, and to what degree, a given scenario dataset 112 is compatible with the scenario associated with the first query. Where the scenario analysis system 104 determines that the first query can be executed on one or more of the scenario datasets 112 and generate results that are responsive to the first query, this scenario analysis system 104 can determine that the one or more scenario datasets 112 satisfy the first scenario. In examples where the scenario analysis system 104 determines that the first query cannot be executed by one or more of the scenario datasets 112 (e.g., because the data returned will be empty, null, etc.), the scenario analysis system 104 can determine that the one or more scenario datasets 112 do not satisfy the first scenario.

In examples where the scenario analysis system 104 determines that few or none of the scenario datasets 112 of the content distribution system 110 satisfy the first scenario, the scenario analysis system 104 can cause the content distribution system 110 to update one or more of the scenario datasets 112 or generate one or more new scenario datasets 112 that satisfy the first scenario. This can include determining one or more updates to make to one or more of the existing scenario datasets 112 to allow the one or more scenario datasets 112 to satisfy the first scenario. In one example, where the scenario analysis system 104 determines that one or more of the scenario datasets 112 are empty, the scenario analysis system 104 can cause the content distribution system 110 to update the tables to include data such as predetermined entries, columns, rows, etc. that can be queried against to generate the first query result. The network component 102 can then provide the first query or a second query that is compatible with the scenario datasets 112 recently updated or generated by the content distribution system 110 when generating one or more query results as described herein.

In examples, the scenario analysis system 104 can implement string matching to determine that the first query can be executed on one or more of the scenario datasets 112. First, the scenario analysis system 104 can analyze the first query to identify elements (e.g., substrings representing a string of text) such as keywords, phrases, or patterns that need to match data in the scenario datasets 112. In this example, the scenario analysis system 104 can implement string matching algorithms (e.g., Levenshtein Distance or Jaccard Similarity) to compare these elements (e.g., these strings of text) against the dataset entries. For instance, Levenshtein Distance measures the minimum number of single-character edits required to change one string into another, allowing for a threshold to be set for acceptable matches. In some examples, SQL pattern matching using LIKE or regular expressions can also be employed to filter scenario datasets 112 based on specific patterns represented by the first query. In examples, the scenario analysis system 104 can determine a first set of substrings that are associated with the first query and compare the first set of substrings to a second set of substrings that are associated with one or more of the scenario datasets 112. When comparing the substrings, the scenario analysis system 104 can determine that at least one substring of the first set of substrings is or is not compatible with one or more substrings of the second set of substrings. And in some examples, the scenario analysis system 104 can normalize one or more of the substrings by removing white space between characters within the query, making all of the characters uppercase or lowercase, etc., and determine whether the substrings match the substrings of the second set of substrings when determining whether one or more of the scenario datasets 112 are compatible with the first query. This normalization can include removing white space, updating words or portions of the substrings to match one or more conventions, etc. If the query scenario matches data in a given scenario dataset 112 within predefined thresholds or patterns, the scenario analysis system 104 can determine that the scenario dataset 112 satisfies the first query. However, if the query scenario does not match the data in a given scenario dataset 112, the scenario analysis system 104 can determine that the scenario dataset 112 does not satisfy the first query and that the first query is not executable on that scenario dataset 112.

In some embodiments, the first query may not be directly executable on one or more scenario datasets 112 that otherwise satisfy the first scenario. For example, the first query may not be executable on a given scenario dataset 112 if the schema according to which it is written in does not match the structure of the scenario dataset 112. In this example, the query processing system 106 can map the schema associated with the first query and convert the first query into a second query that matches the scenario dataset 112. This process can involve identifying equivalent fields or relationships between the two schemas and creating a transformation that translates the original query into a new query compatible with the dataset. In some examples, this mapping can be automated using schema transformation tools or manually by defining a set of rules that specify how elements from the original schema correspond to elements in the target schema. Once the mapping is established, the query processing system 106 can generate a second query based on the transformed schema, allowing the second query to be executed successfully on the scenario dataset 112. In some examples, this mapping can be established by the API described herein. The second query can be represented in accordance with a second format that is at least partially different from the first format.

In an example, the query processing system 106 can obtain a first set of predetermined entries from the client device 108 where the first set of predetermined entries are represented in a first format. This can include a format such as a CSV file and can be used to generate a second query. In this example, the query processing system 106 can generate a second set of predetermined entries based on a mapping. For example, the query processing system 106 can generate a second set of predetermined entries that can map files associated with a first format, such as a CSV file, to files associated with a second format, such as a JSON object. In doing so, the query processing system 106 can execute operations in accordance with the mapping to generate the second set of predetermined entries. The query processing system 106 can then provide the second set of predetermined entries to the content distribution system 110 to cause the content distribution system 110 to insert the second set of predetermined entries into the one or more tables. This can, for example, allow the content distribution system 110 to execute queries and generate query results as described herein.

In some embodiments, the query processing system 106 can determine that the content distribution system 110 was updated in accordance with one or more updates that caused one or more of the scenario datasets 112 to transition from a first state to a second state and, as a result, not be queryable when processing the first query. For example, the query processing system 106 can determine that one or more updates were made to the one or more scenario datasets 112 of the content distribution system 110 over time (e.g., in response to other queries being presented by the client device 108 or another client device is not explicitly illustrated by FIG. 1). These updates can be made to cause one or more of the scenario datasets 112 to comply with one or more queries generated as part of functional testing of software applications by the client device 108. In some examples, these updates can be made as a result of the execution of operations involved in updating the scenario datasets 112. For example, these updates can be made as a result of executing queries that result in updates, including insertions or deletions to one or more of the scenario datasets 112. In these examples, the query processing system 106 can cause the content distribution system 110 to again update the scenario datasets 112 to transition them back from the second state to the first state. In examples where transitioning the scenario datasets 112 from the second state to the first state allows for the first query to be processed in accordance with the updated scenario datasets, the query processing system 106 can then cause one or more queries to be executed by the content distribution system 110 as described herein.

In some examples, the query processing system 106 can cause the content distribution system 110 to update the scenario datasets 112 and cause them to transition to a third state. For example, the query processing system 106 can determine that one or more scenario datasets 112 that are in a second state after having been updated can again be updated to transition the scenario datasets 112 to a third state that is different from both the first and second states. This update can allow the respective scenario datasets 112 to satisfy the first scenario as described herein. For example, this update can involve determining that one or more predetermined entries should be used to update the scenario datasets 112, comparing the entries to the entries of the one or more tables of the respective scenario datasets 112 to determine whether or not the entries are included in the tables, and cause the content distribution system 110 to update the identified scenario datasets 112 by inserting at least a portion of the predetermined entries into the scenario datasets 112. As a result, the query processing system 106 can then generate queries that can be executed in accordance with the first query generated by the client device 108 that target, and can be processed by, these updated scenario datasets 112. By updating this scenario datasets 112 to transition them to this third state, the network component 102 can cause the content distribution system 110 to bring one or more of the scenario datasets 112 into conformity with a given query without the need for version control that would otherwise require the use of extra computing resources and memory to be maintained.

In some embodiments, the network component 102 can receive the first query and determine that the first query is associated with an API request that is configured to cause one or more components of the network component 102 to update one or more of the scenario datasets 112 before executing the first query. For example, the network component 102 can receive the first query and identify both a scenario associated with the first query as well as one or more updates that are indicated by the first query. In this example, the network component 102 can then cause the content distribution system 110 to update one or more of the scenario datasets 112. For example, the network component 102 can then cause the content distribution system 110 to execute one or more operations that add to, remove from, or otherwise update the data maintained in the scenario datasets 112. In some examples, this can involve adding one or more predetermined entries to one or more of the scenario datasets 112, removing some or all of the data maintained by the given scenario datasets 112, or updating portions of the scenario datasets 112.

In some embodiments, the network component 102 can receive the first query and determine that the first query is associated with an API request that is configured to cause the network component 102 to update one or more of the scenario datasets 112 of the content distribution system 110 before execution of the first query. For example, the API request can be configured to cause the machine learning model to update one or more entries of the one or more of these scenario datasets 112 (e.g., tables that are accessible by the network component 102) in the content distribution system 110. This can involve prompting the machine learning model to make one or more changes to the scenario datasets 112 and allowing the scenario datasets to be used when executing the first query and/or a second query that is based on the first query.

In some embodiments, the machine learning model described can include an artificial neural network (ANN) implemented using various types of models such as feedforward neural networks, convolutional neural networks (CNNs), recurrent neural networks (RNNs), long short-term memory networks (LSTMs), etc. Each of these machine learning models can be configured to receive inputs associated with updating one or more portions of a scenario dataset 112. For example, in the context of updating database tables included in the scenario datasets 112, the input can include a request identifying aspects about the updates to be executed, and the output can include corresponding SQL queries or instructions to perform those updates. These instructions can be configured to modify the database accurately and efficiently, allowing for data integrity and consistency.

In some examples, the machine learning models described can be trained by feeding the machine learning models input data and adjusting the model's weights to minimize the error between the predicted output and the actual target. This process is sometimes referred to as backpropagation. During training, the machine learning models can receive input data, process it through multiple layers, and generate an output as described above. The error can be calculated by comparing a difference between the output of the machine learning model to a target (e.g., a predetermined query that represents an expected output), and the weights can then be updated to reduce this error. This iterative process can be repeated until the machine learning model achieves satisfactory performance. The trained machine learning model can then be used to generate queries or other instructions based on new input requests, enabling dynamic and automated updates to database tables.

In some embodiments, the network component 102 can provide the second query to a server such as the content distribution system 110 to cause the content distribution system 110 to return a first query result. For example, the network component 102 can provide the first query to the content distribution system 110 to cause the content distribution system 110 to execute the first query in accordance with one or more of the scenario datasets 112 that are determined to be compatible with the first query. In some examples, the network component 102 can provide the second query to the content distribution system 110 using an API as described herein. For example, the network component 102 can establish a communication connection with the content distribution system 110 and provide the second query along with an indication of one or more of the scenario datasets 112 maintained by the content distribution system 110 when causing the content distribution system 110 to execute the second query. In examples, the content distribution system 110 can execute the second query on the identified scenario datasets 112 to generate the first query result. The content distribution system 110 can then provide the first query result to the network component 102.

In some embodiments, the network component 102 can be configured to generate a second query result based on the first query result. For example, the network component 102 can execute the query processing system 106 to receive the first query result and generate a second query result. In this example, the query processing system 106 can generate the second result based on the mapping between the first format and the second format.

In some embodiments, the network component 102 can provide the second query result to the client device 108. For example, the network component 102 can provide the second query result generated by the query processing system 106 to the client device 108 responsive to the first query. In this example, the network component 102 can provide the second query result to the client device 108 to allow (e.g., cause) the client device 108 to execute one or more functional tests using the second query result.

In some examples, the network component 102 is described as being able to configure the content distribution system 110 such that one or more scenario datasets 112 satisfy scenarios associated with queries generated by the client device 108. However, in some examples, the network component 102 can execute the query processing system 106, which can determine that the scenario datasets 112 maintained by the content distribution system 110 are not accessible or are not compatible with the scenario represented by the query from the client device 108. And one example, the query processing system 106 can determine that a communication connection cannot be established between the network component 102 and the content distribution system 110. In another example, the query processing system 106 can determine that a communication connection is established with the content distribution system 110, but that the scenario datasets 112 do not satisfy the first scenario. In these examples, the query processing system 106 can provide the first query or the second query to the content database 114 to cause the content database 114 to execute the query or queries against the databases maintained by the content database 114. In this example, the database is maintained by the content database 114 can include databases that were preconfigured to be executed in accordance with the first query. For example, the client device 108 can receive input (e.g., from a developer controlling the client device 108) that causes the content database 114 to initialize one or more databases that can be used to execute the first query when performing functional tests as described herein. In this way, the query processing system 106 can redirect the first query to the content database 114 when it is determined that one or more scenario datasets 112 are otherwise inaccessible or unavailable for use by the query processing system 106.

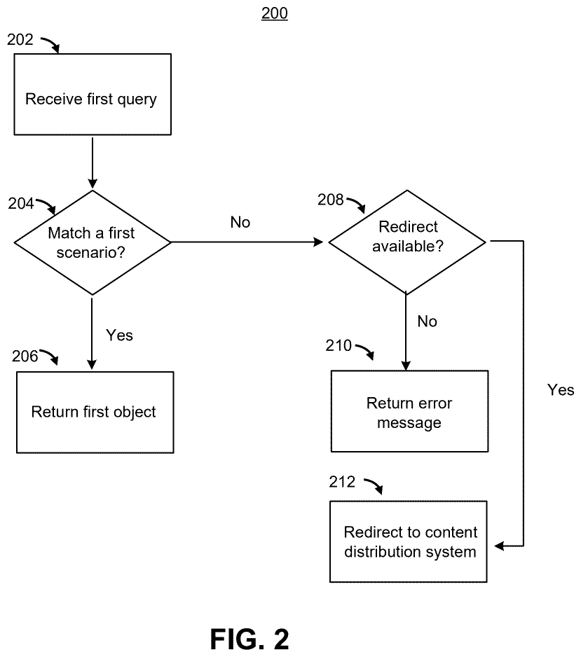

FIG. 2 shows a diagram of a process 200 for establishing a test environment that is cross-compatible with a plurality of client devices, in accordance with one or more embodiments. In some embodiments, one or more of the operations illustrated by the process 200 can be implemented using an environment (e.g., that is the same as, or similar to, the environment 100 of FIG. 1). For example, one or more of the operations illustrated by the process 200 can be implemented using a network component (e.g., that is the same as, or similar to, the network component 102 of FIG. 1). Additionally, or alternatively, one or more of the operations illustrated by the process 200 can be implemented by a device that is different from the network component, such as, for example, a client device (e.g., that is the same as, or similar to, the client device 108 of FIG. 1), a content distribution system (e.g., that is the same as, or similar to, the content distribution system 110 of FIG. 1), and/or a content database (e.g., that is the same as, or similar to, the content database 114 of FIG. 1).

At 202, the process 200 can involve receiving a first query. For example, the network component can receive the first query from one or more client devices that are working to execute functional tests using a test environment. In some examples, the client devices generating the queries can be associated with different compatibility requirements. For example, client devices can have different operating systems, can be configured to execute functional tests using different programming languages, etc.

At 204, the process 200 can involve matching the first query to a first scenario. For example, the network component can implement a scenario analysis system and/or a query processing system (sometimes referred to as a database virtualization service) to analyze queries coming in from client devices. The network component can then determine whether a scenario represented by the query matches scenarios according to which datasets can be queried against and are accessible by the network component. In one example, at 208, the process 200 can involve the network component determining that the query does match one or more scenarios and can then determine whether the network component has established a communication connection with a content distribution system. In this example, process 200 can continue, and at 212, the network component can redirect the first query to be executed by the content distribution system. In another example, where the network component determines that the query does not match one or more scenarios that are represented by the datasets of the content distribution system, the network component can, at 210, return an error message to the client device indicating that there are no datasets according to which the query can be executed. In some examples, where an error message is generated, the network component can then execute the query using a content database as described herein.

In some examples, the network component can determine that a content distribution system is not available to be queried against or that a scenario associated with the first query does not match scenarios represented by the datasets maintained by the content distribution system. In these examples, at 204, process 200 can transition to 206, and the query can be executed against a second database. The second database can include datasets that are generated specifically for the execution of one or more functional tests in accordance with the first scenario.

FIG. 3 shows a diagram of an example implementation 300 of string matching, in accordance with one or more embodiments. In some embodiments, one or more of the operations illustrated by the implementation 300 can be implemented using an environment (e.g., that is the same as, or similar to, the environment 100 of FIG. 1). For example, one or more of the operations illustrated by the implementation 300 can be implemented using a network component (e.g., that is the same as, or similar to, the network component 102 of FIG. 1). Additionally, or alternatively, one or more of the operations illustrated by the implementation 300 can be implemented by a device that is different from the network component, such as, for example, a client device (e.g., that is the same as, or similar to, the client device 108 of FIG. 1), a content distribution system (e.g., that is the same as, or similar to, the content distribution system 110 of FIG. 1), and/or a content database (e.g., that is the same as, or similar to, the content database 114 of FIG. 1).

The implementation 300 can involve a query 302 being represented as a JSON file. For example, a network component can receive a query in a first format such as a CSV file and convert the first query into a second format such as the JSON file. The JSON file can include multiple strings and/or substrings 304 that are used to indicate aspects of a scenario. For example, the substrings 304 can be used to describe how scenarios can be represented by scenario datasets 306, 308, 310 and matched with queries. Portions of each substring 304 can then be compared to the scenario datasets 306, 308, and 310 to determine one or more substring matches. For example, one or more columns of a given scenario can be identified as matching one or more columns of a given scenario dataset 306, 308, or 310. In this example, where the substrings match, a query can be generated to target the data in the corresponding scenario datasets, and the database hosting the scenario datasets can return the relevant data back to the network component. The network component can then provide the data to the client device to allow the client device to execute the functional tests as described herein.

When a query like SELECT*FROM DATATABLE_A WHERE DATATABLE_A.COLUMNNAME_1=“ROWDATA” is executed using a content distribution system, the content distribution system can access and integrate data from multiple sources maintained by the content distribution system. This can allow client devices 108 to provide queries and access data as if the data were stored in a single database, even though the data may be distributed across various physical sources. As a result, the content distribution system can translate the query into the appropriate format for each underlying data source, allowing the data to be retrieved efficiently. In some embodiments, where the query matches a predefined scenario (e.g., Scenario 1) because it contains WHERE DATATABLEA.COLUMNNAME1, the content distribution system can retrieve DataTable A and return it for use during functional testing. This process can simplify data management by providing a unified interface for accessing diverse data sources without knowing their physical locations or formats.

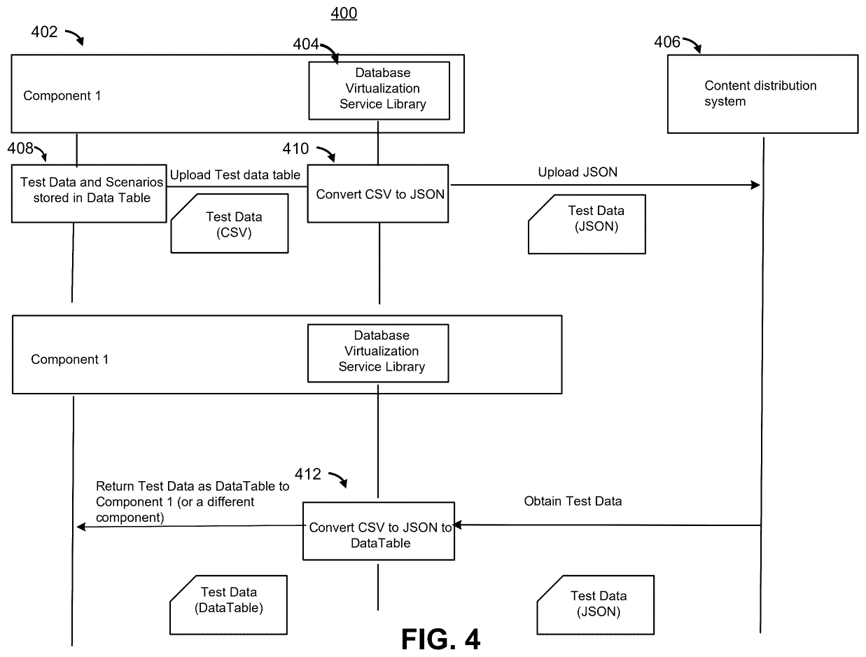

FIG. 4 shows a diagram of an example implementation 400 of obtaining test data (sometimes referred to as cryptographic data in response to one or more operations being executed to protect the test data) in response to the execution of one or more queries, in accordance with one or more embodiments. In some embodiments, one or more of the operations illustrated by the implementation 400 can be implemented using an environment (e.g., that is the same as, or similar to, the environment 100 of FIG. 1). For example, one or more of the operations illustrated by the implementation 400 can be implemented using a network component (e.g., that is the same as, or similar to, the network component 102 of FIG. 1). Additionally, or alternatively, one or more of the operations illustrated by the implementation 400 can be implemented by a device that is different from the network component, such as, for example, a client device (e.g., that is the same as, or similar to, the client device 108 of FIG. 1), a content distribution system (e.g., that is the same as, or similar to, the content distribution system 110 of FIG. 1), and/or a content database (e.g., that is the same as, or similar to, the content database 114 of FIG. 1).

As illustrated by implementation 400, a network component 402 can implement a query processing system that converts CSV files to JSON files. For example, test data 408 associated with one or more scenarios can be provided by the network component 402 to the query processing system to cause the query processing system to transform the test data 408 that is represented as one or more CSV files to test data that is represented in a different format, such as a JSON file. Once converted, the network component 402 can provide the test data as a JSON file to the content distribution system 406. At a later point in time, the network component 402 or a different network component similar to the network component 402 can generate a request in the form of a query and provide that request to the content distribution system 406. The content distribution system 406 pen can then generate response data associated with a query response and provide that response data to the network component 402. The network component 402 can then provide the response data to the query processing system 404 to cause the query processing system 404 to convert the response data into one or more data tables that are compatible with the functional tests being performed by a corresponding client device requesting the test data. In some examples, the network component 402 can then provide the data tables to the client device that generated the request causing the response stated to be obtained by the network component.

FIG. 5 shows illustrative components for a system used to establish a test environment that is cross-compatible with a plurality of client devices, in accordance with one or more embodiments. As shown in FIG. 5, system 500 can include mobile device 522 and user terminal 524. While shown as a smartphone and personal computer, respectively, in FIG. 5, it should be noted that mobile device 522 and user terminal 524 can be any computing device, including, but not limited to, a laptop computer, a tablet computer, a handheld computer, and other computer equipment (e.g., a server), including “smart,” wireless, wearable, and/or mobile devices. FIG. 5 also includes cloud components 510. Cloud components 510 can alternatively be any computing device as described above and can include any type of mobile terminal, fixed terminal, or other device. For example, cloud components 510 can be implemented as a cloud computing system and can feature one or more component devices. It should also be noted that system 500 is not limited to three devices. Users can, for instance, utilize one or more devices to interact with one another, one or more servers, or other components of system 500. It should be noted that, while one or more operations are described herein as being performed by particular components of system 500, these operations can, in some embodiments, be performed by other components of system 500. As an example, while one or more operations are described herein as being performed by components of mobile device 522, these operations can, in some embodiments, be performed by components of cloud components 510. In some embodiments, the various computers and systems described herein can include one or more computing devices that are programmed to perform the described functions. Additionally, or alternatively, multiple users can interact with system 500 and/or one or more components of system 500. For example, in one embodiment, a first user and a second user can interact with system 500 using two different components.

With respect to the components of mobile device 522, user terminal 524, and cloud components 510, each of these devices can receive content and data via input/output (hereinafter “I/O”) paths. Each of these devices can also include processors and/or control circuitry to send and receive commands, requests, and other suitable data using the I/O paths. The control circuitry can comprise any suitable processing, storage, and/or input/output circuitry. Each of these devices can also include a user input interface and/or user output interface (e.g., a display) for use in receiving and displaying data. For example, as shown in FIG. 5, both mobile device 522 and user terminal 524 include a display upon which to display data (e.g., conversational response, queries, and/or notifications).

Additionally, as mobile device 522 and user terminal 524 are shown as touchscreen smartphones, these displays also act as user input interfaces. It should be noted that in some embodiments, the devices can have neither user input interfaces nor displays and can instead receive and display content using another device (e.g., a dedicated display device such as a computer screen and/or a dedicated input device such as a remote control, mouse, voice input, etc.). Additionally, the devices in system 500 can run an application (or another suitable program). The application can cause the processors and/or control circuitry to perform operations related to generating dynamic conversational replies, queries, and/or notifications.

Each of these devices can also include electronic storage. The electronic storages can include non-transitory storage media that electronically store information. The electronic storage media of the electronic storages can include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages can include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages can include one or more virtual storage resources (e.g., cloud storage, a virtual private network, and/or other virtual storage resources). The electronic storages can store software algorithms, information determined by the processors, information obtained from servers, information obtained from client devices, or other information that enables the functionality as described herein.

FIG. 5 also includes communication paths 528, 530, and 532. Communication paths 528, 530, and 532 can include the Internet, a mobile phone network, a mobile voice or data network (e.g., a 5G or LTE network), a cable network, a public switched telephone network, or other types of communications networks or combinations of communications networks. Communication paths 528, 530, and 532 can separately or together include one or more communication paths, such as a satellite path, a fiber-optic path, a cable path, a path that supports Internet communications (e.g., IPTV), free-space connections (e.g., for broadcast or other wireless signals), or any other suitable wired or wireless communication path or combination of such paths. The computing devices can include additional communication paths linking a plurality of hardware, software, and/or firmware components operating together. For example, the computing devices can be implemented by a cloud of computing platforms operating together as the computing devices.

Cloud components 510 can include model 502, which can be a machine learning model, an artificial intelligence model, etc. (which can be referred to collectively as “models” herein). Model 502 can take inputs 504 and provide outputs 506. The inputs can include multiple datasets, such as a training dataset and a test dataset. Each of the plurality of datasets (e.g., inputs 504) can include data subsets related to user data, predicted forecasts and/or errors, and/or actual forecasts and/or errors. In some embodiments, outputs 506 can be fed back to model 502 as input to train model 502 (e.g., alone or in conjunction with user indications of the accuracy of outputs 506, labels associated with the inputs, or with other reference feedback information). For example, the system can receive a first labeled feature input, wherein the first labeled feature input is labeled with a known prediction for the first labeled feature input. The system can then train the first machine learning model to classify the first labeled feature input with the known prediction (e.g., an action graph, a graph characteristic, a graph value, an objective, etc.).

In a variety of embodiments, model 502 can update its configurations (e.g., weights, biases, or other parameters) based on the assessment of its prediction (e.g., outputs 506) and reference feedback information (e.g., user indication of accuracy, reference labels, or other information). In a variety of embodiments, where model 502 is a neural network, connection weights can be adjusted to reconcile differences between the neural network's prediction and reference feedback. In a further use case, one or more neurons (or nodes) of the neural network can require that their respective errors be sent backward through the neural network to facilitate the update process (e.g., backpropagation of error). Updates to the connection weights can, for example, be reflective of the magnitude of error propagated backward after a forward pass has been completed. In this way, for example, the model 502 can be trained to generate better predictions.

In some embodiments, model 502 can include an artificial neural network. In such embodiments, model 502 can include an input layer and one or more hidden layers. Each neural unit of model 502 can be connected with many other neural units of model 502. Such connections can be enforcing or inhibitory in their effect on the activation state of connected neural units. In some embodiments, each individual neural unit can have a summation function that combines the values of all of its inputs. In some embodiments, each connection (or the neural unit itself) can have a threshold function such that the signal must surpass it before it propagates to other neural units. Model 502 can be self-learning and trained, rather than explicitly programmed, and can perform significantly better in certain areas of problem-solving as compared to traditional computer programs. During training, an output layer of model 502 can correspond to a classification of model 502, and an input known to correspond to that classification can be input into an input layer of model 502 during training. During testing, an input without a known classification can be input into the input layer, and a determined classification can be output.

In some embodiments, model 502 can include multiple layers (e.g., where a signal path traverses from front layers to back layers). In some embodiments, backpropagation techniques can be utilized by model 502, where forward stimulation is used to reset weights on the “front” neural units. In some embodiments, stimulation and inhibition for model 502 can be more free-flowing, with connections interacting in a more chaotic and complex fashion. During testing, an output layer of model 502 can indicate whether or not a given input corresponds to a classification of model 502 (e.g., an action graph, a graph characteristic, a graph value, an objective, etc.).

In some embodiments, the model (e.g., model 502) can automatically perform actions based on outputs 506. In some embodiments, the model (e.g., model 502) cannot perform any actions. The output of the model (e.g., model 502) can be used to generate a response in a user interface.

System 500 also includes API layer 550. API layer 550 can allow the system to generate summaries across different devices. In some embodiments, API layer 550 can be implemented on mobile device 522 or user terminal 524. Alternatively, or additionally, the API layer 550 can reside on one or more of the cloud components 510. API layer 550 (which can be a REST or Web services API layer) can provide a decoupled interface to data and/or functionality of one or more applications. API layer 550 can provide a common, language-agnostic way of interacting with an application. Web services APIs offer a well-defined contract, called WSDL, that describes the services in terms of their operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services as well as for exchanging information with partners in B2B transactions.

API layer 550 can use various architectural arrangements. For example, system 500 can be partially based on API layer 550, such that there is strong adoption of SOAP and RESTful Web services, using resources like Service Repository and Developer Portal, but with low governance, standardization, and separation of concerns. Alternatively, system 500 can be fully based on API layer 550, such that separation of concerns between layers like API layer 550, services, and applications is in place.

In some embodiments, the system architecture can use a microservice approach. Such systems can use two types of layers: Front-End Layer and Back-End Layer, where microservices reside. In this kind of architecture, the role of the API layer 550 can provide integration between the Front-End and Back-End. In such cases, API layer 550 can use RESTful APIs (exposition to front-end or even communication between microservices). API layer 550 can use AMQP (e.g., Kafka, RabbitMQ, etc.). API layer 550 can use incipient usage of new communications protocols such as gRPC, Thrift, etc.

In some embodiments, the system architecture can use an open API approach. In such cases, API layer 550 can use commercial or open-source API Platforms and their modules. API layer 550 can use a developer portal. API layer 550 can use strong security constraints by applying WAF and DDoS protection, and API layer 550 can use RESTful APIs as a standard for external integration.

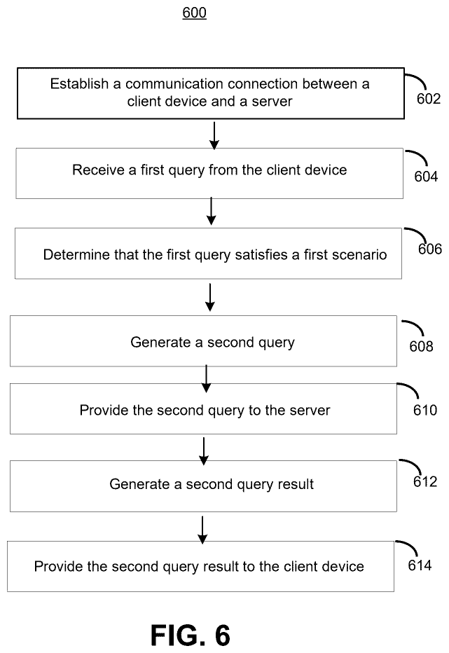

FIG. 6 shows a flowchart of the steps involved in a process 600 for establishing a test environment that is cross-compatible with a plurality of client devices, in accordance with one or more embodiments. For example, a system that is the same as (or similar to) the network component 102 of FIG. 1 (or one or more components thereof) can implement process 600.

At operation 602, the process 600 can include establishing a communication connection between a client device and a server. In some embodiments, a communication connection can be established within a distributed computing environment between a client device and a server in accordance with an application programming interface (API). In this example, the establishment of the connection can be based on predefined protocols and standards specified by the API. In some instances, the API can provide a set of rules and specifications that allow the client device and server to interact seamlessly. In examples, this connection can enable secure and efficient data exchange between the client device and the server.

At operation 604, the process 600 can include receiving a first query from the client devices. In some embodiments, a first query can be received from the client device, with the first query requesting data stored across one or more tables of a database accessible by the server. In this example, the first query can be structured based on the API specifications to ensure proper interpretation by the server. In some instances, the first query can specify the desired data elements and any filtering criteria. In examples, the database accessible by the server can be designed to efficiently store and retrieve large volumes of data across multiple tables. In some cases, the server can process the first query to identify the relevant tables and data elements based on the request parameters.

At operation 606, the process 600 can include determining that the first query satisfies a first scenario. For example, one or more aspects of the first query can be analyzed by a device such as a network component as described herein to determine whether the first query satisfies a first scenario. A first scenario can indicate one or more relationships of data stored in a dataset. In some examples, the first query can target multiple scenario datasets stored by a system such as a content distribution system. As an example, the network component that obtains the first query and determines that the first query is associated with the scenario that matches one or more scenario datasets can identify the respective scenario datasets and provide an indication of the respective scenario datasets to the content distribution system to cause the content distribution system to return relevant data from those datasets.

At operation 608, the process 600 can include generating a second query. For example, a network component that receives the first query and determines that the first query is associated with this scenario satisfied by one or more scenario data sets can generate a second query. The second query can be configured to target the data in the scenario datasets and cause the return of data responsive to the first query. At operation 610, the process 600 can include providing the second query to the server. At operation 612, this can cause the system maintaining the scenario data sets to generate a second query result including the data responsive to the second query.

At operation 614, the process 600 can include providing the second query result to the client device. For example, the network component that transmitted the second query can obtain the second query result and provide the second query result to the client device 108. This can allow the client device to wait to execute one or more functional tests using the second query result.

Some embodiments of the present disclosure are described in connection with a threshold. As described herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

An Application-Specific Integrated Circuit (ASIC) is a specialized hardware chip designed to perform a specific task or set of tasks with high efficiency. Unlike general-purpose processors, such as CPUs or GPUs, ASICs are custom-built for particular applications, optimizing performance, power consumption, and area efficiency. ASICs are widely used in areas such as cryptocurrency mining, telecommunications, and artificial intelligence (AI), where dedicated hardware can provide significant advantages over more flexible but less efficient alternatives. Implementing a large AI model in an ASIC requires designing custom circuits that accelerate the model's computations while ensuring efficient memory management and data movement. Because AI models, particularly deep learning networks, involve extensive matrix multiplications and tensor operations, specialized hardware units such as systolic arrays or tensor processing units (TPUs) can be integrated to optimize these operations. To overcome this challenge, the system may use weight quantization, memory hierarchy optimization, and on-chip interconnects that can be employed to improve throughput and reduce power consumption. To accommodate large models, the system may integrate high-bandwidth memory (HBM) or leverage chiplet architectures, where multiple ASICs work together in a modular fashion to process different portions of the model. Training AI models on an ASIC presents significant challenges since training involves dynamic weight updates and high computational flexibility, which contrasts with the fixed nature of ASICs. To do so, the system may use field-programmable gate arrays (FPGAs) or GPUs during the training phase, then transfer the trained model weights to the ASIC for inference. Alternatively, the system may design ASICs that support on-chip fine-tuning or low-bit precision training, allowing for limited retraining directly on the device. Additionally, co-designing hardware and algorithms ensures that the model architecture is tailored to the ASIC's capabilities, reducing inefficiencies and maximizing performance. By integrating specialized training accelerators, approximate computing methods, and efficient dataflow architectures, ASICs can be optimized for both training and inference, enabling large AI models to operate with minimal energy and latency constraints.

The above-described embodiments of the present disclosure are presented for purposes of illustration and not of limitation, and the present disclosure is limited only by the claims that follow. Furthermore, it should be noted that the features and limitations described in any one embodiment can be applied to any embodiment herein, and flowcharts or examples relating to one embodiment can be combined with any other embodiment in a suitable manner, done in different orders, or done in parallel. In addition, the systems and methods described herein can be performed in real time. It should also be noted that the systems and/or methods described above can be applied to, or used in accordance with, other systems and/or methods.

The present techniques will be better understood with reference to the following enumerated embodiments:
1. Methods for establishing a test environment that is cross-compatible with a plurality of client devices.
2. The method of any one of the preceding embodiments, the method comprising: establishing a communication connection between a client device and a server in accordance with an application programming interface (API); receiving a first query from the client device in a first format, the first query requesting data stored across one or more tables of a database accessible by the server, wherein results of the first query are usable to perform one or more functional tests at the client device; determining that the first query satisfies a first scenario from among a plurality of scenarios, the first scenario representing a set of relationships between the one or more tables of the database; in response to determining that the first query satisfies the first scenario, generating a second query based on a mapping associated with the API, the mapping comprising one or more operations involved in converting the first query into the second query, wherein the second query is represented in accordance with a second format; providing the second query to the server in accordance with the API to cause the server to return a first query result, the first query result represented in accordance with the second format; generating a second query result based on the first query result and the mapping of the first format to the second format; and providing the second query result to the client device to cause the client device to perform the one or more functional tests using the second query result.
3. The method of any one of the preceding embodiments, wherein determining that the first query satisfies the first scenario from among the plurality of scenarios comprises: comparing the first scenario to a set of scenarios associated with the database to determine a first comparison result, the method further comprising: determining the database cannot satisfy the first query based on the first comparison result; and causing the server to configure the database to satisfy the first scenario.
4. The method of any one of the preceding embodiments, wherein causing the server to configure the database to satisfy the first scenario comprises: determining that one or more tables of the database that are involved in generating a response to the first query are empty; and updating the one or more tables to include one or more predetermined entries.
5. The method of any one of the preceding embodiments, wherein the mapping comprises a first mapping, and wherein updating the one or more tables comprises: obtaining a first set of predetermined entries from the client device, the first set of predetermined entries represented in the first format; generating a second set of predetermined entries based on a second mapping associated with the API and the first set of predetermined entries, the second mapping comprising one or more operations involved in converting the first set of predetermined entries into the second set of predetermined entries; and providing the second set of predetermined entries to the server to cause the server to insert the second set of predetermined entries into one or more tables of the one or more tables.
6. The method of any one of the preceding embodiments, wherein comparing the first scenario to the set of scenarios associated with the database comprises: determining a first set of substrings associated with the first query based on the first query; comparing each substring of the first set of substrings to a second set of substrings associated with the database; and determining that at least one substring of the first set of substrings is not comprised in the second set of substrings based on comparing the at least one substring of the first set of substrings to the second set of substrings.
7. The method of any one of the preceding embodiments, wherein the first query is represented as a string of text; and wherein determining the first set of substrings associated with the first query comprises: normalizing the string of text to generate a normalized string of text; and determining the first set of substrings based on the normalized string of text, the first set of substrings corresponding to a portion of the normalized string of text that represents the first scenario.
8. The method of any one of the preceding embodiments, wherein determining that the database cannot satisfy the first query comprises: determining one or more updates made by the server caused the database to transition from a first state to a second state; and wherein updating the database to configure the database to satisfy the first scenario comprises: causing the server to update the database to transition the database from the second state to the first state.
9. The method of any one of the preceding embodiments, wherein determining that the database cannot satisfy the first query comprises: determining one or more updates made by the server caused the database to transition from a first state to a second state; and wherein updating the database to configure the database to satisfy the first scenario comprises: causing the server to update the database to transition the database from the second state to a third state, wherein the database is configured to process the second query while in the third state.
10. The method of any one of the preceding embodiments, wherein causing the server to update the database to transition the database from the second state to the third state comprises: determining one or more predetermined entries based on the first query; comparing the one or more predetermined entries to one or more entries of the one or more tables of the database to determine that at least a subset of the one or more predetermined entries are not comprised in the one or more tables; and causing the server to update the database to insert the subset of the one or more predetermined entries into the database.
11. The method of any one of the preceding embodiments, further comprising: determining the first query is associated with an API request to cause the server to update the one or more tables of the database before the server returns the first query result; and causing the server to update the one or more tables in accordance with the API request.
12. The method of any one of the preceding embodiments, wherein causing the server to update the one or more tables in accordance with the API request comprises: determining one or more predetermined entries based on the first query; and causing the server to update the database to insert at least a subset of the one or more predetermined entries into the database.
13. The method of any one of the preceding embodiments, wherein causing the server to update the one or more tables in accordance with the API request comprises: determining a predetermined set of one or more tables from the one or more tables of the database based on the first query; causing the server to delete tables from the one or more tables of the database that correspond to the predetermined set of one or more tables; and causing the server to insert the predetermined set of one or more tables into the database.
14. The method of any one of the preceding embodiments, further comprising: determining that the first query result returned by the server does not include one or more entries, wherein generating the second query result based on the first query result and the mapping of the first format to the second format comprises: in response to determining that the first query result does not include the one or more entries, providing the first query to a second server in communication with a second database to cause the second server to return the second query result.
15. The method of any one of the preceding embodiments, further comprising: determining the first query is associated with an API request to cause the server to update the one or more tables of the database before the server returns the first query result, the API request configured to cause a machine learning model to receive the first query as input and generate an output, the output comprising a plurality of entries for one or more tables of the database accessible by the server; and causing the server to update the one or more tables in accordance with the API request and the plurality of entries for the one or more tables of the database.
16. One or more non-transitory, computer-readable mediums storing instructions recorded thereon that, when executed by a data processing apparatus, cause the data processing apparatus to perform operations comprising those of any of embodiments 1-15.
17. A system comprising one or more processors and memory storing instructions that, when executed by the processors, cause the processors to effectuate operations comprising those of any of embodiments 1-15.
18. A system comprising means for performing any of embodiments 1-15.

What is claimed is:

1. A system for establishing a secured test environment using a network that is cross-compatible with a plurality of computing devices within the network and providing access to cryptographic data stored in a secured network location of the secured test environment during execution of functional tests by the plurality of computing devices, the system comprising:
one or more processors; and
one or more non-transitory computer-readable mediums having instructions recorded thereon that, when executed by the one or more processors, cause the one or more processors to perform operations comprising:
establishing a secured communication connection within a distributed computing environment between a computing device and a server in accordance with an application programming interface;
receiving a first secured request from the computing device, the first secured request indicating cryptographic data stored across one or more tables of a database accessible by the server,
wherein the first secured request is represented in accordance with a first format that is incompatible with the database, and
wherein results of the first secured request are usable to perform one or more functional tests at the computing device;
determining that the first secured request satisfies a first state from among a plurality of states, the first state representing a set of relationships between the one or more tables of the database;
in response to determining that the first secured request satisfies the first state, generating a second secured request based on a mapping associated with the application programming interface, the mapping comprising one or more operations involved in converting the first secured request into the second secured request,
wherein the second secured request is represented in accordance with a second format that is compatible with the database;
providing the second secured request to the server in accordance with the application programming interface to cause the server to return a first secured request result, the first secured request result represented in accordance with the second format;
generating a second secured request result based on the first secured request result and the mapping of the first format to the second format, wherein the second secured request is represented in accordance with the first format that is compatible with the computing device; and
providing the second secured request result to the computing device to cause the computing device to perform the one or more functional tests using the second secured request result.

2. A method comprising:
establishing a communication connection between a client device and a server in accordance with an application programming interface (API);
receiving a first query from the client device in a first format, the first query requesting data stored across one or more tables of a database accessible by the server,
wherein results of the first query are usable to perform one or more functional tests at the client device;
determining that the first query satisfies a first scenario from among a plurality of scenarios, the first scenario representing a set of relationships between the one or more tables of the database;
in response to determining that the first query satisfies the first scenario, generating a second query based on a mapping associated with the API, the mapping comprising one or more operations involved in converting the first query into the second query,
wherein the second query is represented in accordance with a second format;
providing the second query to the server in accordance with the API to cause the server to return a first query result, the first query result represented in accordance with the second format;
generating a second query result based on the first query result and the mapping of the first format to the second format; and
providing the second query result to the client device to cause the client device to perform the one or more functional tests using the second query result.

3. The method of claim 2, wherein determining that the first query satisfies the first scenario from among the plurality of scenarios comprises:
comparing the first scenario to a set of scenarios associated with the database to determine a first comparison result,
the method further comprising:
determining the database cannot satisfy the first query based on the first comparison result; and
causing the server to configure the database to satisfy the first scenario.

4. The method of claim 3, wherein causing the server to configure the database to satisfy the first scenario comprises:
determining that one or more tables of the database that are involved in generating a response to the first query are empty; and
updating the one or more tables to include one or more predetermined entries.

5. The method of claim 4, wherein the mapping comprises a first mapping, and
wherein updating the one or more tables comprises:
obtaining a first set of predetermined entries from the client device, the first set of predetermined entries represented in the first format;
generating a second set of predetermined entries based on a second mapping associated with the API and the first set of predetermined entries, the second mapping comprising one or more operations involved in converting the first set of predetermined entries into the second set of predetermined entries; and
providing the second set of predetermined entries to the server to cause the server to insert the second set of predetermined entries into one or more tables of the one or more tables.

6. The method of claim 3, wherein comparing the first scenario to the set of scenarios associated with the database comprises:
determining a first set of substrings associated with the first query based on the first query;
comparing each substring of the first set of substrings to a second set of substrings associated with the database; and
determining that at least one substring of the first set of substrings is not comprised in the second set of substrings based on comparing the at least one substring of the first set of substrings to the second set of substrings.

7. The method of claim 6, wherein the first query is represented as a string of text; and
wherein determining the first set of substrings associated with the first query comprises:
normalizing the string of text to generate a normalized string of text; and
determining the first set of substrings based on the normalized string of text, the first set of substrings corresponding to a portion of the normalized string of text that represent the first scenario.

8. The method of claim 3, wherein determining that the database cannot satisfy the first query comprises:
determining one or more updates made by the server caused the database to transition from a first state to a second state; and
wherein updating the database to configure the database to satisfy the first scenario comprises:
causing the server to update the database to transition the database from the second state to the first state.

9. The method of claim 3, wherein determining that the database cannot satisfy the first query comprises:
determining one or more updates made by the server caused the database to transition from a first state to a second state; and
wherein updating the database to configure the database to satisfy the first scenario comprises:
causing the server to update the database to transition the database from the second state to a third state,
wherein the database is configured to process the second query while in the third state.

10. The method of claim 9, wherein causing the server to update the database to transition the database from the second state to the third state comprises:
determining one or more predetermined entries based on the first query;
comparing the one or more predetermined entries to one or more entries of the one or more tables of the database to determine that at least a subset of the one or more predetermined entries are not comprised in the one or more tables; and
causing the server to update the database to insert the subset of the one or more predetermined entries into the database.

11. The method of claim 2, further comprising:
determining the first query is associated with an API request to cause the server to update the one or more tables of the database before the server returns the first query result; and
causing the server to update the one or more tables in accordance with the API request.

12. The method of claim 11, wherein causing the server to update the one or more tables in accordance with the API request comprises:
determining one or more predetermined entries based on the first query; and
causing the server to update the database to insert at least a subset of the one or more predetermined entries into the database.

13. The method of claim 12, wherein causing the server to update the one or more tables in accordance with the API request comprises:
determining a predetermined set of one or more tables from the one or more tables of the database based on the first query;
causing the server to delete tables from the one or more tables of the database that correspond to the predetermined set of one or more tables; and
causing the server to insert the predetermined set of one or more tables into the database.

14. The method of claim 2, further comprising:
determining that the first query result returned by the server does not include one or more entries,
wherein generating the second query result based on the first query result and the mapping of the first format to the second format comprises:
in response to determining that the first query result does not include the one or more entries, providing the first query to a second server in communication with a second database to cause the second server to return the second query result.

15. The method of claim 2, further comprising:
determining the first query is associated with an API request to cause the server to update the one or more tables of the database before the server returns the first query result, the API request configured to cause a machine learning model to receive the first query as input and generate an output, the output comprising a plurality of entries for one or more tables of the database accessible by the server; and
causing the server to update the one or more tables in accordance with the API request and the plurality of entries for the one or more tables of the database.

16. One or more non-transitory, computer-readable mediums comprising instructions that, when executed by one or more processors, cause the one or more processors to perform operations comprising:
receiving a first query requesting data stored across one or more tables of a database in accordance with an application programming interface (API),
wherein the first query is represented in accordance with a first format, and
wherein results of the first query are usable to perform one or more functional tests;
determining that the first query satisfies a first scenario from among a plurality of scenarios, the first scenario representing a set of relationships between the one or more tables of the database;
generating a second query based on a mapping associated with the API in accordance with a second format;
providing the second query in accordance with the API to cause a first query result to be returned, the first query result represented in accordance with the second format;
generating a second query result based on the first query result and the mapping of the first format to the second format; and
providing the second query result to cause the one or more functional tests to be completed using the second query result.

17. The one or more non-transitory, computer-readable mediums of claim 16, wherein the instructions that cause the one or more processors to determine that the first query satisfies the first scenario from among the plurality of scenarios cause the one or more processors to perform operations comprising:
comparing the first scenario to a set of scenarios associated with the database to determine a first comparison result,
the instructions further configured to cause the one or more processors to perform operations comprising:
determining the database cannot satisfy the first query based on the first comparison result; and
causing the database to be configured to satisfy the first scenario.

18. The one or more non-transitory, computer-readable mediums of claim 17, wherein the instructions that cause the one or more processors to cause the database to be configured to satisfy the first scenario cause the one or more processors to perform operations comprising:
determining that one or more tables of the database that are involved in generating a response to the first query are empty; and
updating the one or more tables to include one or more predetermined entries.

19. The one or more non-transitory, computer-readable mediums of claim 18, wherein the mapping comprises a first mapping, and
wherein the instructions that cause the one or more processors to updating the one or more tables cause the one or more processors to perform operations comprising:
obtaining a first set of predetermined entries represented in the first format;
generating a second set of predetermined entries based on a second mapping associated with the API and the first set of predetermined entries, the second mapping comprising one or more operations involved in converting the first set of predetermined entries into the second set of predetermined entries; and
providing the second set of predetermined entries to cause the second set of predetermined entries to be inserted into one or more tables of the one or more tables.

20. The one or more non-transitory, computer-readable mediums of claim 18, wherein the instructions that cause the one or more processors to compare the first scenario to the set of scenarios associated with the database cause the one or more processors to perform operations comprising:
determining a first set of substrings associated with the first query based on the first query;
comparing each substring of the first set of substrings to a second set of substrings associated with the database; and
determining that at least one substring of the first set of substrings is not comprised in the second set of substrings based on comparing the at least one substring of the first set of substrings to the second set of substrings.
